(19) United States
(12) Patent Application Publication
(10) Pub. No.: US 2020/0228586 A1
(43) Pub. Date: Jul. 16, 2020

(54) EFFICIENT IMMERSIVE STREAMING

(71) Applicant: Fraunhofer-Gesellschaft zur Förderung der angewandten Forschung e.V., Munich (DE)

(72) Inventors: Robert SKUPIN, Berlin (DE); Cornelius HELLGE, Berlin (DE); Yago SÁNCHEZ DE LA FUENTE, Berlin (DE); Thomas SCHIERL, Berlin (DE)

(21) Appl. No.: 16/837,638

(22) Filed: Apr. 1, 2020

Related U.S. Application Data
(63) Continuation of application No. PCT/EP2018/076882, filed on Oct. 2, 2018.

(30) Foreign Application Priority Data
Oct. 2, 2017 (EP) 17194475.4

(51) Int. Cl. H04L 29/06; H04N 21/218; H04N 19/70; H04N 21/4728; H04N 21/6587; H04N 21/845

(52) U.S. Cl. CPC H04L 65/601; H04L 65/608; H04N 21/21805; H04N 21/8456; H04N 21/4728; H04N 21/6587; H04N 19/70

(57) ABSTRACT

Immersive video streaming is rendered more efficient by introducing into an immersive video environment the concept of switching points and/or partial random access points or points where conveyed mapping information metadata indicates that the frame-to-scene mapping remains constant with respect to a first set of one or more regions while changing for another set of one or more regions. In particular, the entities involved in immersive video streaming are provided with the capability of exploiting the circumstance that immersive video material often shows constant frame-to-scene mapping with respect to a first set of one or more regions in the frames, while differing in the frame-to-scene mapping only with respect to another set of one or more regions.

### CROSS-REFERENCES TO RELATED APPLICATIONS

This application is a continuation of copending International Application No. PCT/EP2018/076882, filed Oct. 2, 2018, which is incorporated herein by reference in its entirety, and additionally claims priority from European Application No. EP 17 194 475.4, filed Oct. 2, 2017, which is incorporated herein by reference in its entirety.

The present application is concerned with concepts for, or suitable for, immersive video streaming.

### BACKGROUND OF THE INVENTION

In recent years, there has been a lot of activity around Virtual Reality (VR) as evidenced by large industry engagement. Dynamic HTTP Adaptive Streaming (DASH) is expected to be one of the main services for 360 video.

There are different streaming approaches for sending 360° video to a client. One straight-forward approach is a viewport-independent solution. With this approach, the entire 360° video is transmitted in a viewport agnostic fashion, i.e. without taking the current user viewing orientation or viewport into account. The issue of such an approach is that bandwidth and decoder resources are consumed for pixels that are ultimately not presented to the user as they are outside of his viewport.

A more efficient solution can be provided by using a viewport-dependent solution. In this case, the bitstream sent to the user will contain higher pixel density and bitrate for the picture areas that are presented to the user (i.e. viewport).

Currently, there are two typical approaches used for viewport dependent solutions. From streaming perspective, e.g. in a DASH based system, the user selects an Adaptation Set based on the current viewing orientation in both viewport dependent approaches.

The two viewport dependent approaches differ in terms of video content preparation. One approach is to encode different streams for different viewports by using a projection that puts an emphasis in a given direction (e.g. left side of FIG. 1, ERP with shifted camera center/projection surface) or by using some kind of region wise packing (RWP) over a viewport agnostic projection and (e.g. right side of FIG. 1 based on regular ERP) thus defining picture regions of the projection or preferred viewports that have a higher resolution than others non-preferred viewports.

Another approach for viewport dependency is to offer the content in the form of multiple bitstreams that are the result of splitting the whole content into multiple tiles. A client can then download a set of tiles corresponding to the full 360 degree video content wherein each tiles varies in fidelity, e.g. in terms of quality or resolution. This tiled-based approach results in a preferred viewport video with picture regions at higher quality than others.

For simplicity, the following description assumes that the non-tiled solution applies, but the problems, effects and embodiments described further below are also applicable for tiled-streaming solutions.

For any of the viewports, we can have a stream the decoded pictures of which are illustrated in FIG. 2. FIG. 2 illustrates at the left-hand side a panoramic video and, inscribed thereinto, two different viewports VP1 and VP2 as examples for different viewports. For both viewport positions, a respective stream is prepared. As shown in the upper half of FIG. 2, the decoded pictures of the stream for viewport VP1 comprise a relatively large portion into which VP1 is coded, whereas the other portion, shown at the left-hand side of the picture area, contains the whole panoramic video content, here rotated and downscaled. The other stream for viewport VP2 has decoded pictures composed in substantially the same manner, i.e. a relatively large right-hand portion has VP2 encoded thereinto, while the remaining portion has encoded thereinto the rotated and downscaled version of the panoramic video.

How the pictures are composed from the original full content is typically defined by metadata, such as region-wise packing details which exist as SEI message in the video elementary stream or as a box in the ISO base media file format. Taking the OMAF environment as an example, FIG. 3 shows an example for entities usually cooperating in an immersive video streaming environment at the client side. FIG. 3 shows an immersive video streaming client device, here exemplarily depicted as corresponding to OMAF-DASH client model. The DASH-retrieved media segments and the manifest file or media presentation description enters the client essential component of which is formed by the virtual reality application, which receives via metadata sensor data from sensors, the sensor data relating to the head and/or eye movement of the user so as to move the viewport, and controls and interacts with the media related components including the DASH access engine responsible for retrieving the media segments, the DASH media engine responsible for depacketizing and defragmenting the coded video stream contained in the file format stream resulting from a concatenation of the retrieved media segments forwarded by the DASH access engine, as well as a renderer which finally renders the video to be presented to the user via, for instance, a head-up display or the like.

As said, FIG. 3 shows a high level Client model of a DASH streaming service as envisioned in the Omnidirectional MediA Format (OMAF) standard. OMAF (among others), describes 360 video and transport relevant metadata and how this is encapsulated into the ISO base Media File Format (ISOBMFF) or within the video bitstream (e.g. HEVC bitstream). In such an streaming scenario, typically, DASH is used and there, the downloaded elementary stream is encapsulated into the ISOBMFF in Initialization Segments and Media Segments. Each of the Representations (corresponding to a preferred viewing direction bitstream and given bitrate) is conformed of an Initialization Segment and one or more Media segments (i.e. consisting of one or more ISOBMFF media fragments, where the NAL units for a given time interval are encapsulated). Typically, the client downloads a given Initialization segment and parses each header (movie box, aka. ‘moov’ box). When the ISOBMFF parser in FIG. 3 parses the ‘moov’ box it extracts the relevant information about the bitstream and decoder capabilities and initializes the decoder. It does the same with the rendering relevant information and initializes the renderer. This means that the ISOBMFF parser (or at least its module responsible of parsing the ‘moov’ box) has an API (Application-Programming-Interface) to be able to initialize the decoder and renderer with given configurations at the beginning of the play back of a stream.

In the OMAF standard, the region-wise packing box (‘rwpk’) is encapsulated within the sample entry (also in the ‘moov’ box) as to describe the properties of the bitstream for the whole elementary stream. This form of signaling guarantees a client (FF demux+decoder+renderer) that the media stream will stick to a given RWP configuration, e.g. either VP1 or VP2 in FIG. 2.

However, in the described viewport dependent solution, it is typical that the whole content is available at a lower resolution for any potential viewport as illustrated through the light blue shaded box in FIG. 2. Changing the viewport (VP1 to VP2) with such an approach means that the DASH client need to download another Initialization segment with the new corresponding ‘rwpk’ box. Thus, when parsing the new ‘moov’ box, the ISOBMFF does a re-initialization of the decoder and renderer since the file format track is switched. This leads to the fact that using a full-picture RAP is required for viewport switching which is detrimental to coding efficiency. In fact, a re-initialization of the decoder without a RAP would lead to a non-decodable bitstream, The viewport switching is illustrated in FIG. 4.

That is, FIG. 4 shows the stream for VP1 on top of the stream for VP2. The temporal access extents from left to right. FIG. 4 shows that, periodically, RAPs (Random Access Points) are present in both streams, mutually adjusted to one another temporally so that a client may switch from one stream to the other during streaming. Such a switching is illustrated in FIG. 4 at the third RAP. As indicated in FIG. 4, a file format demultiplexing and a decoder re-initialization are necessary at this switching occasion owing to the above-outlined facts.

It would be preferred if the immersive video streaming could be rendered more efficiently.

### SUMMARY

According to an embodiment, data having a scene encoded thereinto for immersive video streaming may have: a set of representations, each representation including a video, video frames of which are subdivided into regions, wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions, wherein each of the representations is fragmented into fragments covering temporally consecutive time intervals of the scene, each fragment of each representation including mapping information on the mapping between the video frames and the scene with respect to the second set of one or more regions of the video frames within the respective fragment, wherein the video frames are encoded such that the set of representations may have, for each representation, a set of random access points for which video frames within a fragment of the respective representation, which is temporally aligned to any of the set of random access points, are encoded independent from previous fragments of the respective representation within the first and second sets of one or more regions, and, for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

According to another embodiment, a manifest file may have: a first syntax portion defining a first adaptation set of first representations, first RAPs for random access to each of the first representations and first SPs for switching from one of the first representations to another, a second syntax portion defining a second adaptation set of second representations, second RAPs for random access to each of the second representations and second SPs for switching from one of the second representations to another, and an information on whether the first SPs and second SPs are additionally available for switching from one of the first representations to one of the second presentations and from one of the second representations to one of the first presentations, respectively.

According to another embodiment, a media file including a video may have: a sequence of fragments into which consecutive time intervals of a scene are coded, wherein video frames of the video included in the media file are subdivided into regions, wherein the regions of the video frames spatially coincide among video frames within different media file fragments, with respect to a first set of one or more regions, wherein the videos frames have the scene encoded thereinto, wherein a mapping between the videos frames and the scene is common among all fragments within a first set of one or more regions, and differs among the fragments within a second set of one or more regions outside the first set of one or more regions, wherein each fragment includes mapping information on the mapping between the video frames and the scene with respect to the second set of one or more regions of the video frames within the respective fragment, wherein the video frames are encoded such that the fragments include predetermined ones within which video frames are encoded independent from previous fragments within the second set of one or more regions, but predictively dependent on previous fragments differing in the mapping within the second set of one or more regions compared to the predetermined fragments, within the first set of one or more regions.

According to another embodiment, an apparatus for generating data encoding a scene for immersive video streaming may be configured to: generate a set of representations, each representation including a video, video frames of which are subdivided into regions, such that the regions of the video frames spatially coincide among the representations with respect to a first set of one or more regions, wherein a mapping between the video frames and the scene is common to all representations within the first set of one or more regions and differs among the representations within a second set of one or more regions outside the first set of one or more regions, each of the representations is fragmented into fragments covering temporally consecutive time intervals of the scene, wherein the apparatus is configured to provide each fragment of each representation with mapping information on the mapping between the video frames and the scene with respect to the second set of one or more regions of the video frames within the respective fragment, wherein the video frames are encoded such that the set of representations include for each representation, a set of random access points for which video frames within a fragment of the respective representation, which is temporally aligned to any of the set of random access points, are encoded independent from previous fragments of the respective representation within the first and second sets of one or more regions, and for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

Another embodiment may have an apparatus for streaming scene content from a server by immersive video streaming, the server offering the scene by way of: a set of representations, each representation including a video, video frames of which are subdivided into regions, wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions, wherein each of the representations is fragmented into fragments covering temporally consecutive time intervals of the scene, each fragment of each representation including mapping information on the mapping between the video frames and the scene with respect to the second set of one or more regions of the video frames within the respective fragment, wherein the video frames are encoded such that the set of representations include, for each representation, a set of random access points for which video frames within a fragment of the respective representation, which is temporally aligned to any of the set of random access points, are encoded independent from previous fragments of the respective representation within the first and second sets of one or more regions, and, for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions, wherein the apparatus is configured to switch from one representation to another at one of the switching points of the other representation.

Another embodiment may have a server offering a scene for immersive video streaming, the server offering the scene by way of: a set of representations, each representation including a video, video frames of which are subdivided into regions, wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions, wherein each of the representations is fragmented into fragments covering temporally consecutive time intervals of the scene, each fragment of each representation including mapping information on the mapping between the video frames and the scene with respect to the second set of one or more regions of the video frames within the respective fragment, wherein the video frames are encoded such that the set of representations include, for each representation, a set of random access points for which video frames within a fragment of the respective representation, which is temporally aligned to any of the set of random access points, are encoded independent from previous fragments of the respective representation within the first and second sets of one or more regions, and, for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

According to another embodiment, a video decoder configured to decode a video from a video bitstream may be configured to: derive from the video bitstream a subdivision of video frames of the video into a first set of one or more regions and a second set of one or more regions, wherein a mapping between the video frames and a scene remains constant within the first set of one or more regions, wherein the video decoder is configured to check mapping information updates which update the mapping for the second set of one or more regions in the video bitstream, and recognize a partial random access point with respect to the second set of one or more regions responsive to a change of the mapping with respect to the second set of one or more regions, and/or interpret the video frames' subdivision as a promise that motion-compensation prediction used by the video bitstream to encode the video frames, predicts video frames within the first set of one or more regions from reference portions within reference video frames exclusively residing within the first set of one or more regions, and/or inform a renderer for rendering an output video of the scene out of the video on the mapping between the video frames and the scene by way of mapping information meta data accompanying the video, wherein the mapping information meta data indicates the mapping between the video frames and the scene once or at a first update rate with respect to the first set of one or more regions and at a second update rate with respect to the second set of one or more regions which is higher than the first update rate.

According to another embodiment, a renderer for rendering an output video of a scene out of a video and mapping information meta data which indicates a mapping between the video's video frames and the scene may be configured to: distinguish, on the basis of the mapping information meta data, a first set of one or more regions of the video frames for which the mapping between the video frames and the scene remains constant, and a second set of one or more regions within which the mapping between the video frames and the scene varies according to updates of the mapping information meta data.

According to another embodiment, a video bitstream video frames of which have encoded thereinto a video may include: information on a subdivision of the video frames into regions, wherein the information discriminates between a first set of one or more regions within which a mapping between the video frames and a scene remains constant, and a second set of one or more region outside the first set one or more regions, and mapping information on the mapping between the video frames and the scene, wherein the video bitstream contains updates of the mapping information with respect to the second set of one or more regions.

According to another embodiment, a method for generating data encoding a scene for immersive video streaming may have the step of: generating a set of representations, each representation including a video, video frames of which are subdivided into regions, such that the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions, each of the representations is fragmented into fragments covering temporally consecutive time intervals of the scene, wherein the method is configured to provide each fragment of each representation with mapping information on the mapping between the video frames and the scene with respect to the second set of one or more regions of the video frames within the respective fragment, wherein the video frames are encoded such that the set of representations include, for each representation, a set of random access points for which video frames within a fragment of the respective representation, which is temporally aligned to any of the set of random access points, are encoded independent from previous fragments of the respective representation within the first and second sets of one or more regions, and, for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

Another embodiment may have a method for streaming scene content from a server by immersive video streaming, the server offering the scene by way of: a set of representations, each representation including a video, video frames of which are subdivided into regions, wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions, wherein each of the representations is fragmented into fragments covering temporally consecutive time intervals of the scene, each fragment of each representation including mapping information on the mapping between the video frames and the scene with respect to the second set of one or more regions of the video frames within the respective fragment, wherein the video frames are encoded such that the set of representations include, for each representation, a set of random access points for which video frames within a fragment of the respective representation, which is temporally aligned to any of the set of random access points, are encoded independent from previous fragments of the respective representation within the first and second sets of one or more regions, and, for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions, wherein the method is configured to switch from one representation to another at one of the switching points of the other representation.

According to another embodiment, a method for decoding a video from a video bitstream may be configured to: derive from the video bitstream a subdivision of video frames of the video into a first set of one or more regions and a second set of one or more regions, wherein a mapping between the video frames and a scene remains constant within the first set of one or more regions, wherein the method for decoding is configured to check mapping information updates which update the mapping for the second set of one or more regions in the video bitstream, and recognize a partial random access point with respect to the second set of one or more regions responsive to a change of the mapping with respect to the second set of one or more regions, and/or interpret the video frames' subdivision as a promise that motion-compensation prediction used by the video bitstream to encode the video frames, predicts video frames within the first set of one or more regions from reference portions within reference video frames exclusively residing within the first set of one or more regions, and/or inform a renderer for rendering an output video of the scene out of the video on the mapping between the video frames and the scene by way of mapping information meta data accompanying the video, wherein the mapping information meta data indicates the mapping between the video frames and the scene once or at a first update rate with respect to the first set of one or more regions and at a second update rate with respect to the second set of one or more regions which is higher than the first update rate.

According to another embodiment, a method for rendering an output video of a scene out of a video and mapping information meta data which indicates a mapping between the video's video frames and the scene may be configured to: distinguish, on the basis of the mapping information meta data, a first set of one or more regions of the video frames for which the mapping between the video frames and the scene remains constant, and a second set of one or more regions within which the mapping between the video frames and the scene varies according to updates of the mapping information meta data.

Another embodiment may have a non-transitory digital storage medium having a computer program stored thereon to perform the method for streaming scene content from a server by immersive video streaming, the server offering the scene by way of: a set of representations, each representation including a video, video frames of which are subdivided into regions, wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions, wherein each of the representations is fragmented into fragments covering temporally consecutive time intervals of the scene, each fragment of each representation including mapping information on the mapping between the video frames and the scene with respect to the second set of one or more regions of the video frames within the respective fragment, wherein the video frames are encoded such that the set of representations include for each representation, a set of random access points for which video frames within a fragment of the respective representation, which is temporally aligned to any of the set of random access points, are encoded independent from previous fragments of the respective representation within the first and second sets of one or more regions, and for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions, wherein the method is configured to switch from one representation to another at one of the switching points of the other representation, when said computer program is run by a computer.

Another embodiment may have a non-transitory digital storage medium having a computer program stored thereon to perform the method for decoding a video from a video bitstream, configured to: derive from the video bitstream a subdivision of video frames of the video into a first set of one or more regions and a second set of one or more regions, wherein a mapping between the video frames and a scene remains constant within the first set of one or more regions, wherein the method for decoding is configured to check mapping information updates which update the mapping for the second set of one or more regions in the video bitstream, and recognize a partial random access point with respect to the second set of one or more regions responsive to a change of the mapping with respect to the second set of one or more regions, and/or interpret the video frames' subdivision as a promise that motion-compensation prediction used by the video bitstream to encode the video frames, predicts video frames within the first set of one or more regions from reference portions within reference video frames exclusively residing within the first set of one or more regions, and/or inform a renderer for rendering an output video of the scene out of the video on the mapping between the video frames and the scene by way of mapping information meta data accompanying the video, wherein the mapping information meta data indicates the mapping between the video frames and the scene once or at a first update rate with respect to the first set of one or more regions and at a second update rate with respect to the second set of one or more regions which is higher than the first update rate, when said computer program is run by a computer.

An idea underlying the present invention is the fact that immersive video streaming may be rendered more efficient by introducing into an immersive video environment the concept of switching points and/or partial random access points or points where conveyed mapping information metadata indicates that the frame-to-scene mapping remains constant with respect to a first set of one or more regions while changing for another set of one or more regions. In particular, the idea of the present application is to provide the entities involved in immersive video streaming with the capability of exploiting the circumstance that immersive video material often shows constant frame-to-scene mapping with respect to a first set of one or more regions in the frames, while differing in the frame-to-scene mapping only with respect to another set of one or more regions. Entities being informed in advance about this circumstance may suppress certain measures they normally would undertake and which would be more cumbersome as if these measures were completely left off or restricted to this set of one or more regions the frame-to-scene mapping of which is subject to variation. For instance, the compression efficiency penalties usually associated with random access points such as the disallowance of using frames preceding the random access points by any frame at the random access point or following thereto, may be restricted to the set of one or more regions subject to the frame-to-scene mapping variation. Likewise, a renderer may take advantage of the knowledge of a constant nature of the frame-to-scene mapping for a certain set of one or more regions in performing the rendition.

### BRIEF DESCRIPTION OF THE DRAWINGS

Embodiments of the present invention will be detailed subsequently referring to the appended drawings, in which:

FIG. 1 shows a schematic diagram illustrating viewport dependent 360 video schemes wherein, at the left-hand side, the possibility of shifting the camera center is shown in order to change the area in the scene where, for instance, the sample density generated by projecting the frames' samples onto the scene using the frame-to-scene mapping is larger than for other regions, while the right-hand side illustrates the usage of region-wise packing (RWP) in order to generate different representations of a panoramic video material, each representation being specialized for a certain preferred viewing direction, wherein it is the latter sort of individualizing representations which the subsequently explained embodiments of the present application relate to;

FIG. 2 shows a schematic diagram illustrating the viewport dependent or region-wise packing streaming approach with respect to two exemplarily shown preferred viewports and corresponding representations; FIG. 2 the region-wise definition of the frames of representations associated with a viewport location VP1 and for a viewport location VP2, respectively, wherein both frames, or—to be more precise, the frames of both representations—have a co-located region containing a downscaled full content region which is shown cross-hatched, wherein FIG. 2 merely serves as an example for an easier understanding of subsequently explained embodiments;

FIG. 3 shows a block diagram of a client apparatus where embodiments of the present application may be implemented, wherein FIG. 3 illustrates a specific example where the client apparatus corresponds to the OMAF-DASH streaming client model and shows the corresponding interfaces between the individual entities contained therein;

FIG. 4 shows a schematic diagram illustrating two representations only using static RWP between which a client switches for sake of viewport switching from VP1 to VP2 at RAPs;

FIG. 5 shows a schematic diagram illustrating two representations between which a client switches for sake of viewport switching from VP1 to VP2 at a switching point in accordance with an embodiment of the present application where dynamic RWP is used;

FIG. 6 shows a syntax example for mapping information distinguishing between static and dynamic regions, respectively;

FIG. 7 shows a schematic block diagram illustrating entities involved in immersive video streaming which entities may be embodied to operate in accordance with embodiments of the present application;

FIG. 8 shows a schematic diagram illustrating the data offered at the server in accordance with an embodiment of the present application;

FIG. 9 shows a schematic diagram illustrating the portion of a downloaded stream around a switching point from one viewport (VP) to another in accordance with an embodiment of the present application;

FIG. 10 shows a schematic diagram illustrating a content and structure of a manifest file in accordance with an embodiment of the present application; and

FIG. 11 shows a schematic diagram illustrating a possible grouping of representation into adaptation sets in accordance with the manifest file of FIG. 10.

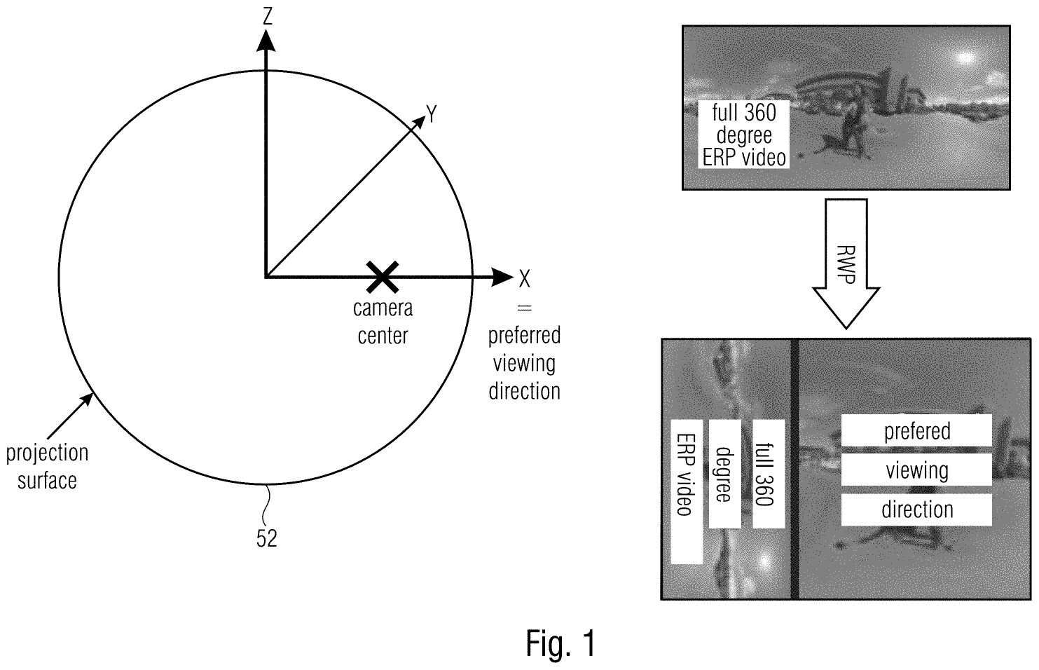

### DETAILED DESCRIPTION OF THE INVENTION

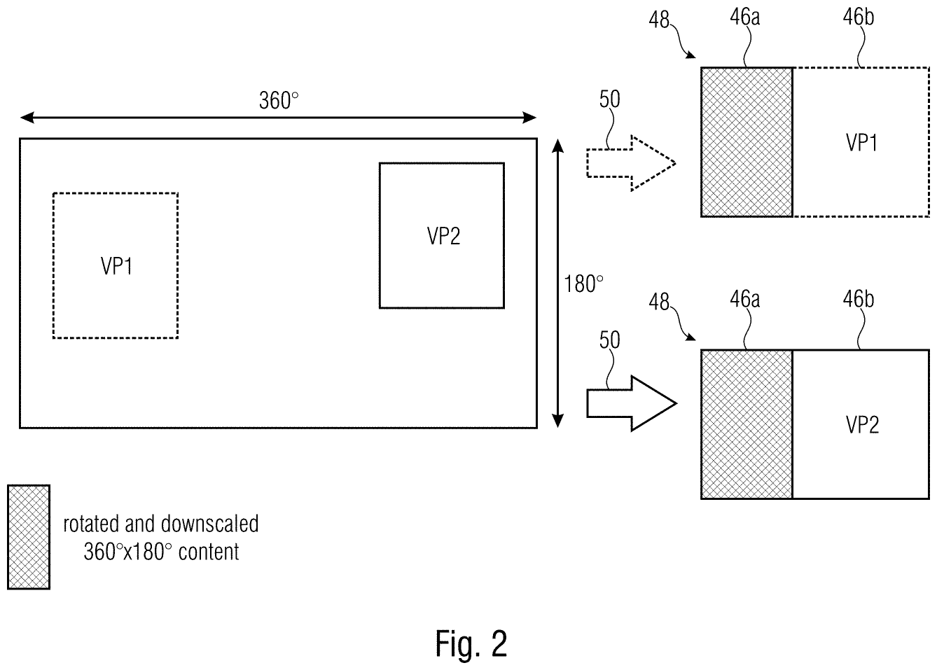

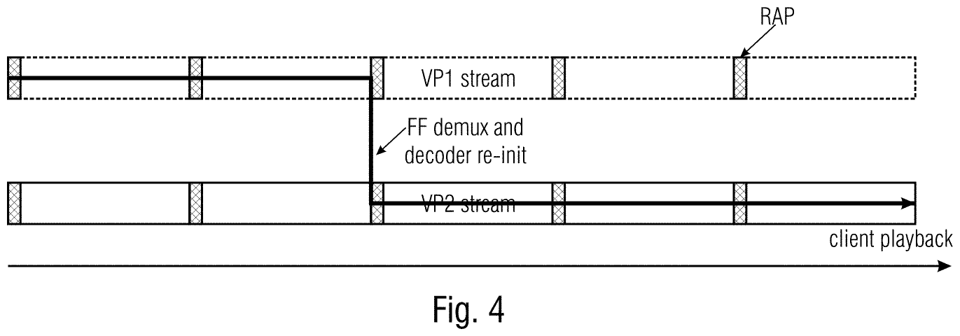

Before describing certain embodiments of the present application, the description in the introductory portion of the specification of the present application shall be resumed. In particular, the description stopped at FIG. 4 by explaining the inefficiency associated with switching from one representation to another although the nature of the representations is such that, with respect to a certain set of one or more frame regions, here the left-hand one, depicted in FIG. 2, actually coincides among the representations.

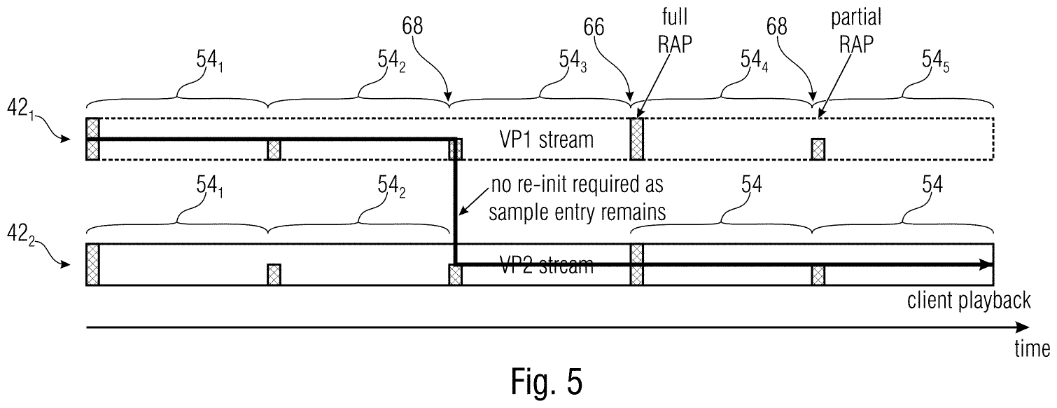

In particular, since some picture portion, e.g. the low-resolution whole content (cross-hatched in FIG. 2) could be available in all bitstreams, decoding this area would not require re-initialization of the decoder and allow for non-RAP decoding start (for this cross-hatched picture area) which would be desirable to increase the coding efficiency. According to some embodiments described below a picture region specific guarantee about the dynamicity of the RWP configuration is allowed, which can be facilitated in the reset of the coding prediction chain. This scenario is illustrated with full and partial RAP in FIG. 5, where Full RAP corresponds to the RAP in FIG. 4 (shown as blocks of complete height) and Partial RAP (shown as blocks of half height) corresponds to the fact that only parts of the picture, i.e. the non-static and VP specific areas (such as the right-hand side of frame region in FIG. 2) are coded without dependency on pictures preceding the Partial RAP in bitstream order, while the static part of the picture, i.e. the low-resolution variant of the whole 360 degree video content (shown cross-hatched in FIG. 2) is coded in a predictive fashion using pictures preceding the Partial RAP in bitstream order.

With an extension of the RWP information, where indication of dynamicity of RWP and description of its regions is provided, the ISOBMFF parser could at the Initialization Segment initialize the renderer in a dynamic mode. The ISOBMFF parser (or corresponding module for parsing ‘moov’ box) would initialize the decoder and initialize the renderer. This time, the renderer would be initialized either in a static mode, fully dynamic mode, or partially dynamic mode as explained below. The API to the renderer would allow to be initialized at different ways and if configured in a dynamic mode and/or partially dynamic mode, would allow for in-bitstream re-configuration of the regions described in the RWP.

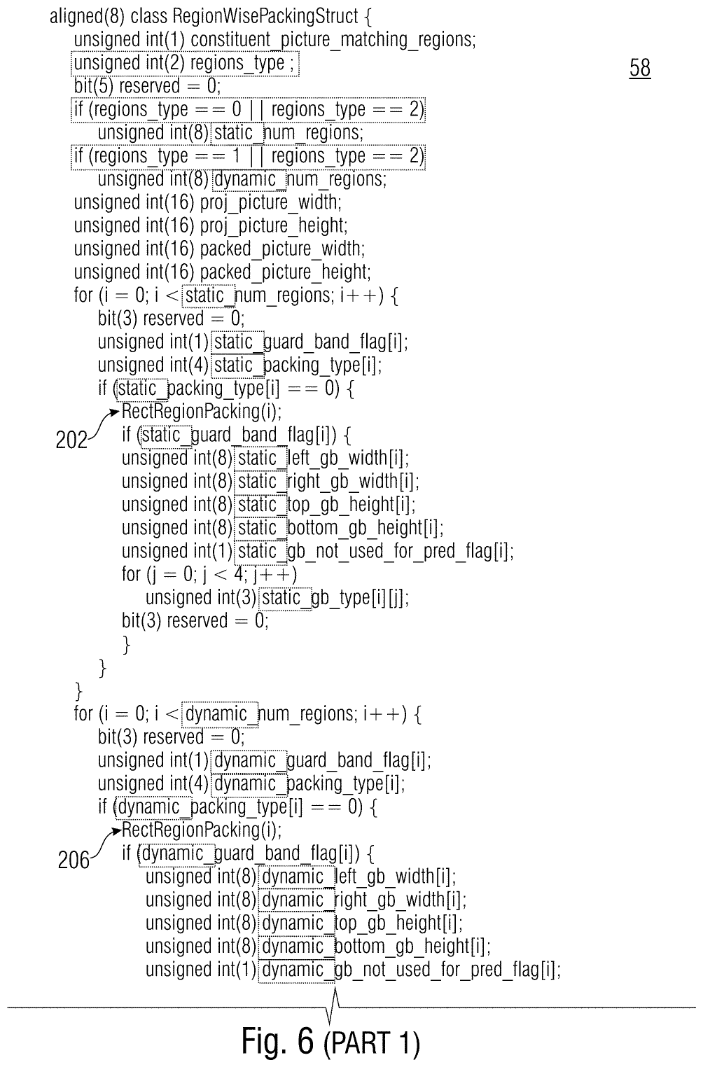

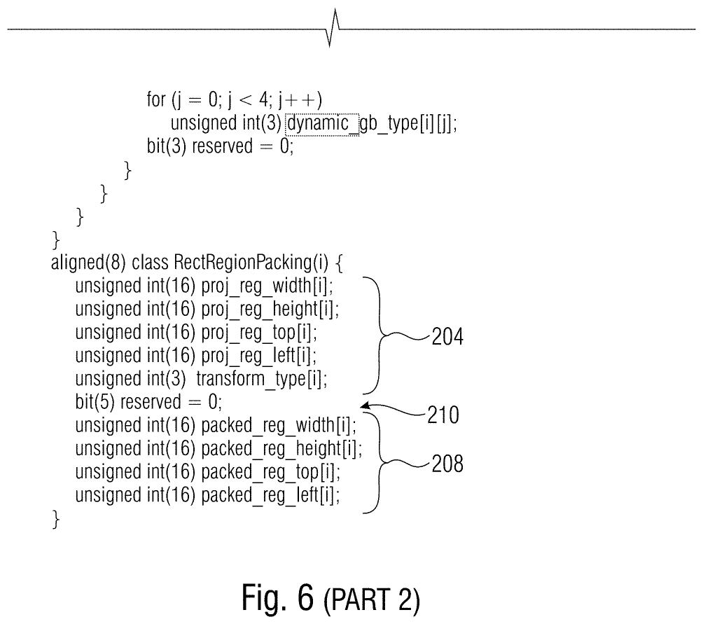

An embodiment could be as shown in FIG. 6. Here, regions_type is equal to 0 if region-wise packing is constant/static for all pictures within the elementary stream. If 1, region-wise packing is allowed to change for every picture. And if equal to 2 region-wise packing defines a set of regions that are static for the whole elementary stream and some region that are allowed to change. If mode 2 is used, when parsing the ‘rwpk’ box at the Initialization Segments. The renderer could be initialized in a way that some of the part of the decoded pictures are mapped for the whole service to part or whole of the 360 video; while other parts of the decoded picture are configured dynamically and can be updated with the renderer API.

Thus, the content can be constraint to contain the low-resolution version of the whole 360 video in a static fashion for the whole video stream.

Since in a DASH scenario, download happens typically at (sub)segment boundaries (which correspond to one or more ISOBMFF fragments), in a non-guided view it would be beneficial for a DASH client to be sure that the dynamic region-wise happen does not change at finer granularity than a (sub)segment. Thus, the client knows that when downloading a (sub)segment all pictures within that (sub)segment have the same region-wise packing description. Therefore, another embodiment is to constrain the dynamicity of region-wise packing to change only (if region type equal to 2) on a fragment basis. I.e., the dynamic regions are described again or presence of SEI at fragment start is mandated. All SEIs within the bitstream are then constraint to have the same value as the region-wise packing description at the ISOBMFF fragment.

Another embodiment is based on any of the above but with the constraint that the number of dynamic regions indicated in the RegionWisePackingStruct in the sample entry is kept constant; as well as their dimensions. The only thing that can change is the position of the packed and/or projected regions. Obviously, it would be possible to have a great flexibility in number of regions on the static or dynamic regions, and as long as the same content is covered (e.g. same coverage) leave it open to a flexibility that would lead to the most efficient transport for each moment and each viewport. However, this would require a renderer that can cope with very big variations, what could typically lead to complexity. When the initialization of the renderer is done, if there is a promise on the number of regions that stay static and the number of region that are dynamic; and on how the dimensions are; implementation and operation of such a renderer can be much less complex and can be performed easily; thus facilitating APIs from the ISOBMFF parser (or corresponding module) to operate and configure the renderer on the fly.

Still, in such a service; if no specific constraints are set and promised to the user, it can be that an efficient streaming service cannot be provided. Imagine for instance, a service where there are N viewports: VP1, VP2 . . . VPN. If VP1 to VP4 had the same static regions and VP5 to VPN as well; but the static region of these 2 sets were different, the client operation would become a bit more complicated since switching from one of the viewports VP1 . . . VP4 to one of the viewports VP5 . . . VPN could only be performed at full RAPs; which would require a DASH client having a more complex operation checking availability of full RAPs and potentially leading to some delays to wait for a full RAP availability. Therefore, another embodiment is based on any of the above but with the constraint of a media/presentation profile that is signalled in e.g. a manifest (such as the Media Presentation Description—MPD) mandating that all Adaptation Sets with same coverage and/or viewpoint have the same static configuration of the static regions.

In the current DASH Standard, there are 2 types of signalling that can be used for switching. One is RandomAccess@interval, which describes the interval of Random Access Points (RAP) within a Representation. Obviously, since a RAP can be used for starting decoding and presenting the content of a Representation, such a point can be used to switch from one Representation to another. Another attribute that is defined in DASH is SwitchingPoint@interval. This attribute can be used to locate the switching points for a given Representation. These switching points differ from RAPs in that they cannot be used to start decoding from this point onwards, but can be used to continue processing and decoding the bitstream from that Representation from this point onwards if decoding of another Representation of the same Adaptation Set had already started. However, it is impossible for a client to know whether switching from one Representation in one Adaptation Set to another Representation of another Adaptation Set at Switching Points results is something that can be decoded and presented correctly. One further embodiment is new signalling as a new element or descriptor to the MPD, e.g. CrossAdaptationSwitchingPoints as an element that is true or false meaning that Switching Points can be used across Adaptation Sets. Or even CrossAdaptationSwitchingPoints being signalled within Adaptation Sets and being an integer, meaning that Adaptation Sets with the same integer value belong to a group of Adaptation Sets for which switching cross different Adaptation Sets leads to a valid bitstream that can be processed and decoded correctly. The previous embodiment where all Adaptation Sets with same coverage and/or viewpoint have the same static configuration of the static regions can be also extended as that when a given media/presentation profile is indicated in the MPD CrossAdaptationSwitchingPoints is interpreted to be as true or that all Adaptation Sets with same coverage and/or viewpoint have the same have the same integer value. Or just that the corresponding constraints are fulfilled without further necessary indication than the profile indication.

Another embodiment deals with coded pictures in a ISOBMFF fragment that reference pictures of a previous fragment; where the referencing pictures can only use references in the static part of the current picture and from the static part of former pictures. Samples and/or any other element (e.g. Motion Vectors) from the dynamic part cannot be used for decoding. For the dynamic part, RAP or a Switching point signaling is mandated.

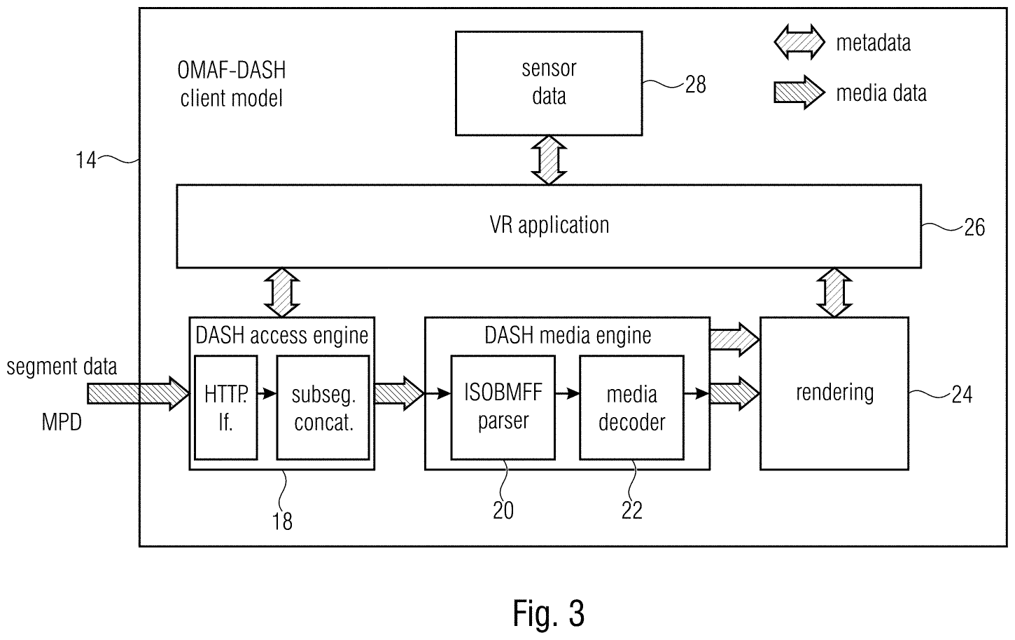

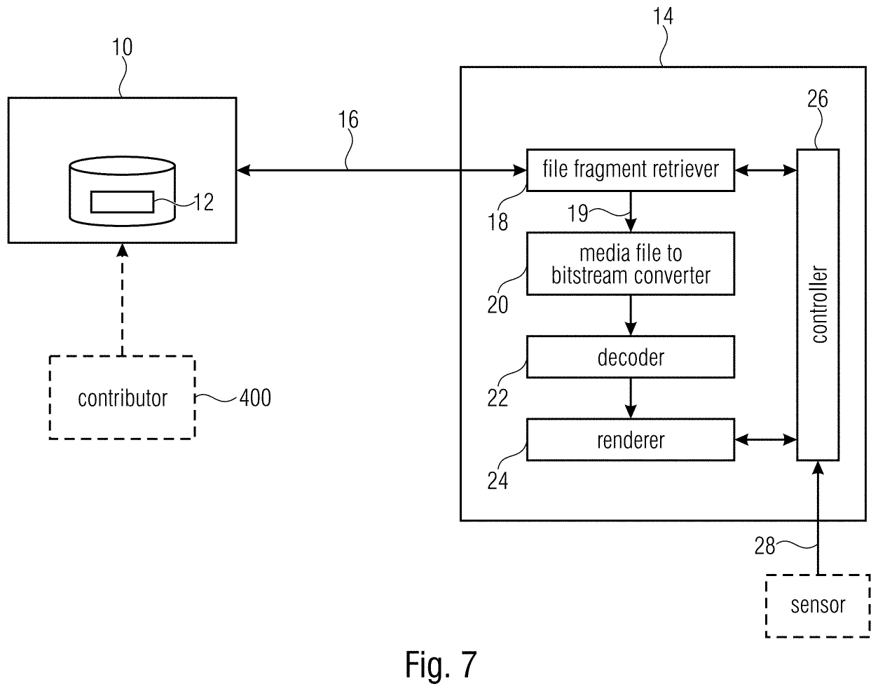

Thus, summarizing the above, it has been one of the ideas underlying the above-described embodiments that an immersive video streaming may be set up at improved characteristics such as in terms of bandwidth consumption or, alternatively, video quality at equal bandwidth consumption. The immersive video streaming environment may, as depicted in FIG. 7, involve a server 10 where data 12 having a scene encoded thereinto is stored, and a client apparatus 14 which is connected to server 10 via a network 16 such as the internet and/or a mobile network and so forth. The client apparatus 14 comprises several components among which there is a file fragment retriever 18 such as a dash client engine, a media file to video bitstream converter 20, a decoder 22, a renderer 24 and a controller 26 which controls the retriever 18 and renderer 24, for instance, on the basis of inbound sensor data 28 indicating, for instance, a current user's viewing direction. The client apparatus 14 may be constructed according to FIG. 3.

One of the ideas underlying the above-described embodiments is that a more efficient immersive video streaming may be achieved if the data 12 representing the scene is designed in a special manner, namely in that the video frames coincide in a first set of one or more regions with respect to the mapping between the video frames and the scene in all representations, but they also comprise a second set of one or more regions within which the mapping varies among the representations, thereby rendering them view port specific.

Details are described hereinbelow. As shown, a contributor 400 may have generated or prepared the data 12 which is then offered to the client 14 at server 10. It forms an apparatus for generating the data 12 encoding a scene for immersive video streaming. Within each representation, the first set of regions and the second set of regions are clearly discriminated from each other so that a finally downloaded concatenation of fragments having been derived from data 12 by switching between the various representations, maintains this characteristic, namely the continuity with respect to the first set of regions, while being dynamic with respect to the second set of regions. In case of no switching, though, the mapping would be constant. However, owing to viewport location changes, the client apparatus seeks to switch from one representation to another. Re-initialization or re-opening a new media file every time the representation is changed, is not necessary as the base configuration remains the same, namely the mapping with respect to the first set of regions remains constant, while the mapping is dynamic with respect to the second set of regions.

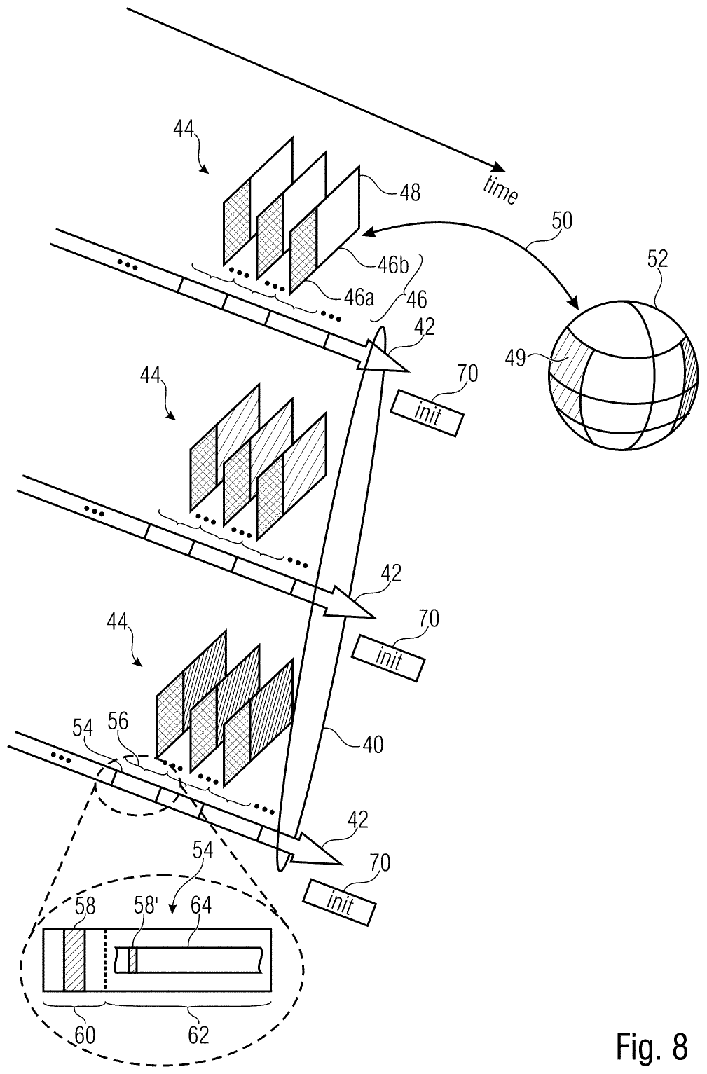

To this end, data 12 comprises as depicted in FIG. 8 a set 40 of representations 42 where each representation comprises a video 44, the video frames of which are subdivided into regions 46. In particular, there is a first set of one or more regions 46a which are common to all representations 42, i.e. with respect to which the spatial subdivision of the video frames 48 of the videos 44 of all representations 42 coincides. The remaining part of video frames 48 of videos 44 of all representations 42 may be subdivided into one or more regions 46b in a manner differing among representations 42 although a spatially coinciding case is shown in the present application. The difference between regions of type 46a and 46b is the following: the mapping 50 between the video frames 48 on the one hand and the scene 52 on the other hand, remains constant or is the same for all representations 42. To this end, the scene 52 represented, for instance, as a panoramic sphere is, or is partially, mapped onto region 46a of video frames 44 in a manner coinciding among representations 42. Mapping 50 is different, however, among representations 42 as far as regions 46b are concerned. A coincidence in mapping 50 involves, for instance, the location and size of the respective region within the video frames' area, the location and size of the mapping's image of this region within the scene 52, such as the image 49 of region 46b of picture 48 of the middle representation 42 shown in FIG. 8, and the projection or transform type or sample mapping between the region and its image. A difference in mapping, in turn, involves a deviation in any of these parameters. For region 46a, all these characteristics are the same among representations 24, i.e. region 46a is of the same size and located at the same location within the video frames 48 of all representations. The video frames 48 are of the same size, for instance, among all representations 42 with region 46b, however, being, for instance, although being co-located and being of the same size within the video frames' area, related to a different image within scene 52 by mapping 50. Hence, region 56b of video frames 48 of one representation shows, for instance, another section of scene 52 compared to region 46b of video frames 48 of another representation. In other words, the mapping 50 between the videos frames of the respective representation and the scene remains constant within region 46a while the mapping 50 between the videos frames and the scene may differ among the representations within region 46b in terms of 1) a location of an image of regions 46b of the video frames in the scene according to the mapping 50 and/or 2) a circumference of the set of dynamic regions such as region 46b and/or 3) a sample mapping between the dynamic region and the image thereof in the scene 52. Detailed examples were described above with respect to the example of VP1 and VP2 in FIG. 2. As shown in the latter example, the spatial resolution at which a portion of the scene is coded into a region 46b might be increased compared to a resolution at which the scene or a portion thereof is coded into the static region 46a. Likewise, the mapping's image of region 46b within the scene 52 may by larger than that of region 46a.

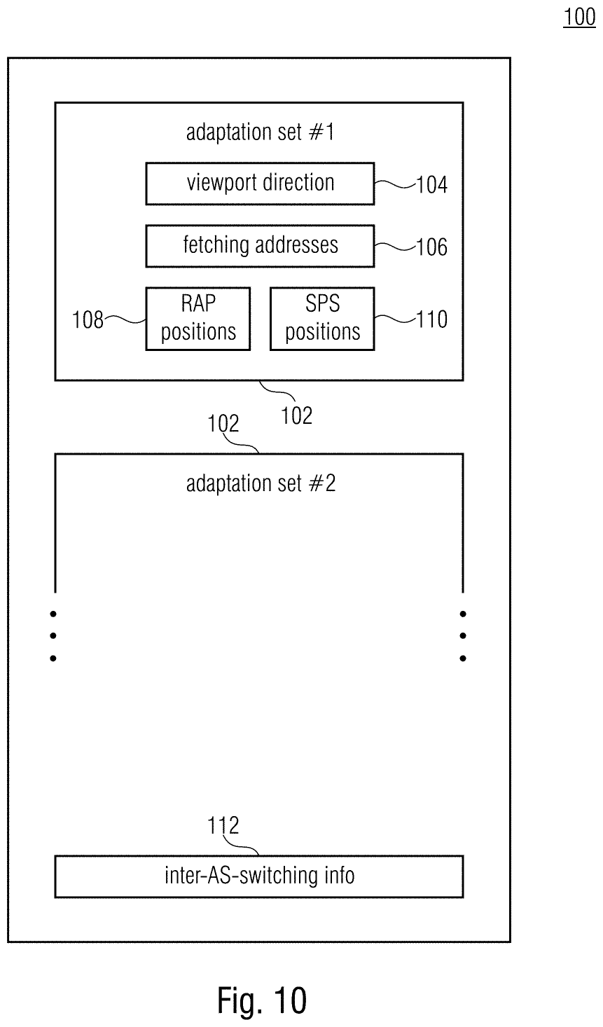

Each representation 42, as depicted in FIG. 5, is fragmented into fragments 54 which cover temporally consecutive time intervals 56 of the respective video 44 for the scene 52, respectively. Each fragment 54 comprises mapping information 58 on the mapping 50 at least with respect to the second set of one or more regions 46b of the video frames 48 within the respective representation 42, fragment 54 belongs to. As has been described above, this mapping information 58 may, for instance, be contained in the media file headers. It may additionally comprise information on mapping 50 as far as the first set of one or more regions 46a of the video frames 48 within the respective fragment 54 is concerned although this pertains to the constant portion of the video frames. Additionally or alternatively, mapping information 58 is contained in the video bitstream comprised by each fragment 54 such by way of an SEI message. This means the following: each representation 42 may, in fact, be a media file composed of a sequence of fragments 54, each fragment 54 could comprise a media file header 60 and one or more payload portions 62 or, in alternative terms—media file fragments forming a run of such media file fragments. The payload portion 62 carries a fragment of a video bitstream which has the video frames 48 within the time interval 56 coded thereinto to which fragment 54 belongs. This video bitstream fragment 64 contains mapping information 58′ within, for instance, an SEI message. The fragments 54 are those fragments at units of which file fragment retriever 18 is able to retrieve the representations 42 from server 10. To this end, for instance, file fragment retriever 18 computes respective addresses such as HTTP addresses on the basis of a manifest file or media representation description obtained from server 10. An example for such file is illustrated in FIG. 10. The mapping information 58 may define the mapping 50 for a predetermined region 46a/b in terms of one or more of the following:
the predetermined region's intra-video-frame position, as done, for instance, in the example of FIG. 8 for any region, 46a, i of the static type via calling at 202 syntax portion RectRegionPacking and for any region, 46b, i of the dynamic type via calling at 206 syntax portion RectRegionPacking, at 204, respectively; the syntax at 204 defines, quasi, a circumference of the regions by defining the location of one of the corners and width and height; alternatively, two diagonally opposite corners may be defined for each region;
the predetermined region's scene position, as done, for instance, in the example of FIG. 8 for any region, 46a, i of the static type via calling at 202 the syntax portion RectRegionPacking and for any region, 46b, i of the dynamic type via calling at 206 syntax portion RectRegionPacking, at 208, respectively; the syntax at 204 defines, quasi, a location of an image 49 of each region in the scene according to the mapping 50 by defining the location of one of the corners (or two crossing edges such as defined by latitude and longitude) and width and height of the image (such as defined by latitude and longitude offsets); alternatively, two diagonally opposite corners may be defined for each region (such as defined by two latitudes and two longitudes);
the predetermined region's video-frame to scene projection, i.e. an indication of the exact manner at which, internally, the respective region 46a/b is mapped onto sphere 52; this is done, for instance, in the example of FIG. 8 for any region, 46a, i of the static type via calling at 202 the syntax portion RectRegionPacking and for any region, 46b, i of the dynamic type via calling at 206 syntax portion RectRegionPacking, at 210, respectively, namely here exemplarily by indexing some predefined transform/mapping type; in other words, a sample mapping between the second set of one or more regions and the image thereof in the scene is defined here.

Further, the representations 42 have the video frames 48 encoded in a certain manner, namely in that they comprise random access points 66 and switching points 68. Random access points may be aligned among the representations. A fragment of a certain random access point may be encoded independent from previous fragments of the respective representation with respect to both types of regions 46a and 46b. Region 54₄, for instance, is coded independent from any previous fragment 54₁ to 54₃ within both region types 46a and 46b, since this fragment 54₄ is associated with, or is temporarily aligned to, a random access point 66. Fragments associated with, or temporarily aligned to, switching points 68 are encoded independent from previous fragments of the respective representation 42, as indicated at 122, merely with respect to regions of the second type, i.e. region 46b, but predictively dependent on, as indicated at 124, previous fragments within region 46a. Region 54₅, for instance, is such a fragment having prediction dependency to any of previous fragments 54₁ to 54₄ as far as region 46a is concerned, thereby lowering the necessary bit rate for these fragments compared to RAP fragments.

Owing to the design of data 10 in the manner outlined above, the media stream downloaded by client apparatus 14 remains valid in that the constant characteristics remain the same with respect to each of representation 42 of this data 10. In order to illustrate this, let's assume the above-illustrated case of switching from representation 42₁ to 42₂. Data 12 comprises, for instance, an initialization segment 70 for each representation 42, the initialization segment comprising a file header of the respective representation 42. The initialization segment 70 or the header inside segment 70—the reference sign is sometimes reused for the header therein—comprises the mapping information 58—or, in different wording, another instantiation thereof—at least as far as the constant region 46a is concerned. It may, however, alternatively comprise the mapping information 58 with respect to the complete mapping 50, i.e. with respect to regions 46a and 46b with discriminating between both, i.e. indicating the one region as being constant, namely region 46a and the other as being dynamic, i.e. region 46b. Interestingly, the discrimination does not yet make sense when looking at representation 42 as residing at server 10 individually. The meaning and sense thereof, however, becomes clear when looking at the media file finally downloaded by client apparatus 14. As a further note it should be noted that the reference sign 58 for the mapping information has now been used semantically for actually different instantiations thereof at different locations: at the fragments and at the initialization segments. The reason for reusing the reference sign is the semantic coincidence of the information.

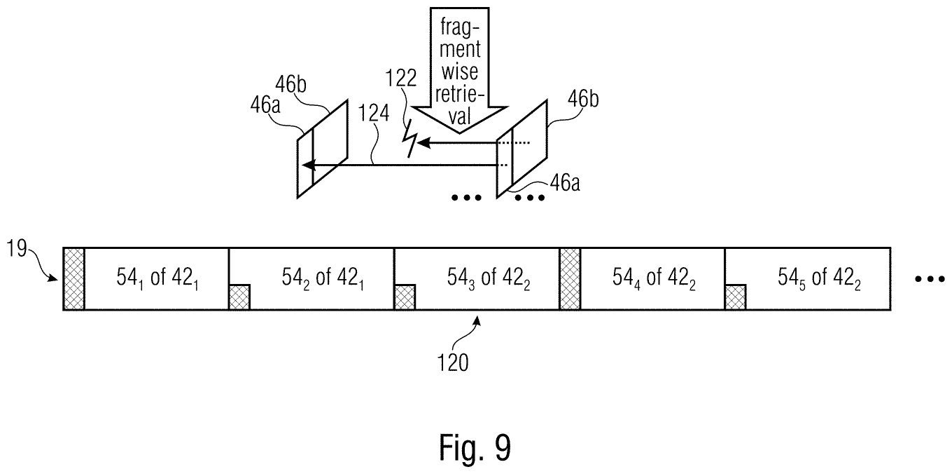

In particular, when downloading, file fragment retriever 18 starts with retrieving the initialization segment 70 of the firstly downloaded representation along with a firstly retrieved segment of this representation. The first representation is 42₁ in the above example. Then, at some switching point 68, file fragment retriever 18 switches from representation 42₁ to representation 42₂. FIG. 9 shows a respective portion out of such downloaded stream 19 of fragments retrieved around such a switching 120 from one to the other representation. File fragment retriever 18 does not need, however, to retrieve the initialization segment of representation 42₂. No new file needs to be started. Rather, file fragment retriever 18 directly continues with retrieving fragment 54₃ of representation 42₂ being associated with, or temporarily aligned to, switching point 68, which has, as described above, the mapping information 58 in its fragment header 60. The client apparatus 14 or, to be more precise, the file fragment retriever 18 comprised by the latter, thus, forms an apparatus for streaming scene content from server 10 by immersive video streaming and is configured to switch from one representation to another at one of the switching points of the other representation.

The media file to bitstream converter 20 receives from file fragment retriever 18 the sequence of downloaded fragments, i.e. fragments 54₁ and 54₂ of representation 42₁ followed by fragment 54₃ of representation 42₂ and so forth, and does not see any conflict or motivation to reinitialize decoder 22: the media file header has been received by media file to bitstream converter 20 merely once, namely at the beginning, i.e. prior to fragment 54₁ of representation 42₁. Further, the constant parameters remain constant, namely the mapping information with respect to region 46a. The varying information does not get lost and is still there for its addressee, namely renderer 24.

The media file to bitstream converter 20, first, receives the downloaded media bitstream which is a media file, composed of a sequence of fragments stemming from different representation files 42, strips off the fragment header 60 and forwards the pack of fragmented video bitstream by concatenating its fragment 64. Decoder 22 turns the mapping information 58′ within the video bitstream formed by the sequence of bitstream fragments 64 into metadata which decoder 22 forwards to renderer 24 so as to accompany the video which the decoder 22 decodes from the video bitstream. The renderer 24, in turn, is able to render output frames from the video which decoder 22 has decoded from the inbound downloaded video bitstream. The output frames show a current viewport.

Thus, the decoder receives from the converter 20 a video bitstream into which a video of video frames is encoded. The video bitstream itself may comprises the mapping information 50 such as in form is SEI messages. Alternatively, the decoder receives this information in form of meta data. The mapping information informs the decoder on the mapping 50 between the video frames and the scene, wherein the video bitstream contains updates of the mapping information with respect to the second set of one or more regions.

Decoder 22 may take advantage of the fact that there are different types of regions 46a and 46b, namely constant ones and dynamic ones.

For instance, video decoder 22 may inform renderer 24 on the mapping 50 merely once or at a first update rate with respect to region 46a and at a second update rate with respect to region 46b, with the second update rate being higher than the first update rate, thereby lowering the metadata amount from decoder 22 to renderer 24 compared to the case where the complete mapping 50 is updated on each occasion of a change of mapping 50 with respect to dynamic region 46b. The decoder may inform the renderer on the mapping between the video frames and the scene by way of mapping information meta data accompanying the video output by the decoder, wherein the mapping information meta data may indicate the mapping between the video frames and the scene once, i.e. for that moment, and is then updated by respective meta data updates. The mapping information meta data may have a similar or even the same syntax as the mapping information instantiations discussed so far.

Additionally or alternatively, video decoder may interpret the vide frames' subdivision into constant region(s) and dynamic region(s) as a promise that motion compensation prediction used by the video bitstream to encode the video frames, predicts video frames within region 46a from reference portions within reference video frames exclusively residing within the first set of one or more regions of the reference video frames. In other words, motion compensation for regions 46a might be kept within the respective region's borders so as to predict the region 46a within one picture from the co-located region 46a within a reference picture only, i.e. without reaching out into, or without the motion prediction extending beyond the region's border into, any other region or, at least, no region of the dynamic type such as region 46b. This promise may be used by the decoder to assign the static regions 46a to a decoding in parallel to decoding of dynamic regions in a manner not having to temporally align the decoding of a region 46a to the current development of the decoding of a region 46b in the same picture. The decoder may even exploit the promise so as to commence decoding an edge portion of a static region 46a of a current video frame prior to decoding an adjacent portion of any dynamic region 46b of the motion compensation reference video frame.

And further, video decoder may additionally or alternatively exploit the fact that switching points are a kind of partial random access points, namely in order to de-allocate currently consumed storage space in its decoded picture buffer (DPB) with respect to no-longer needed regions 46b of video frames of fragments prior to the switching point. In other words, the decoder may survey the mapping information updates conveyed by information 58 in the retrieved fragments which update the mapping 50 for the second set of one or more regions in the video bitstream in order to recognize occasions at which a change of the mapping 50 with respect to the second set of one or more regions takes place such as at fragment 120. Such occasions may then be interpreted by the decoder 22 as a partial random access point, namely a partial RAP with respect to the region 46b with the consequence of performing the just-outlined de-allocation of DPB storage capacity for regions 46b of reference pictures guaranteed to be no longer in use. As shown in the example of FIG. 6, the mapping information 58 may be designed in a manner that the decoder may distinguish static regions from dynamic regions by a syntax order at which the mapping information sequentially relates to one or more static regions and one or more dynamic regions. For example, the decoder reads a first number of the static regions, namely static_num_regions, and a second number of the dynamic regions, namely dynamic_num_regions, (see FIG. 6), and then reads region specific information (e.g. 204, 210 and 208) from the mapping information on the regions as often as the sum of both numbers with interpreting the first number as the static regions and the second number as the dynamic regions. The order between static and dynamic regions may naturally be switched. Alternatively, instantiations of such region specific information may be read a number of times corresponding to the overall number of static and dynamic regions, with each region specific information comprising an indication or flag, i.e. an association syntax element, indicating whether the respective region which the respective region specific information relates to is static or dynamic.

And renderer 24, in turn, may also take advantage of the knowledge that some regions, namely region 46a, are of constant nature: for these regions renderer 24 may apply a constant mapping from the inbound decoded video to the output video, while using a more complicated step-wise transformation for dynamic regions such as region 46b.

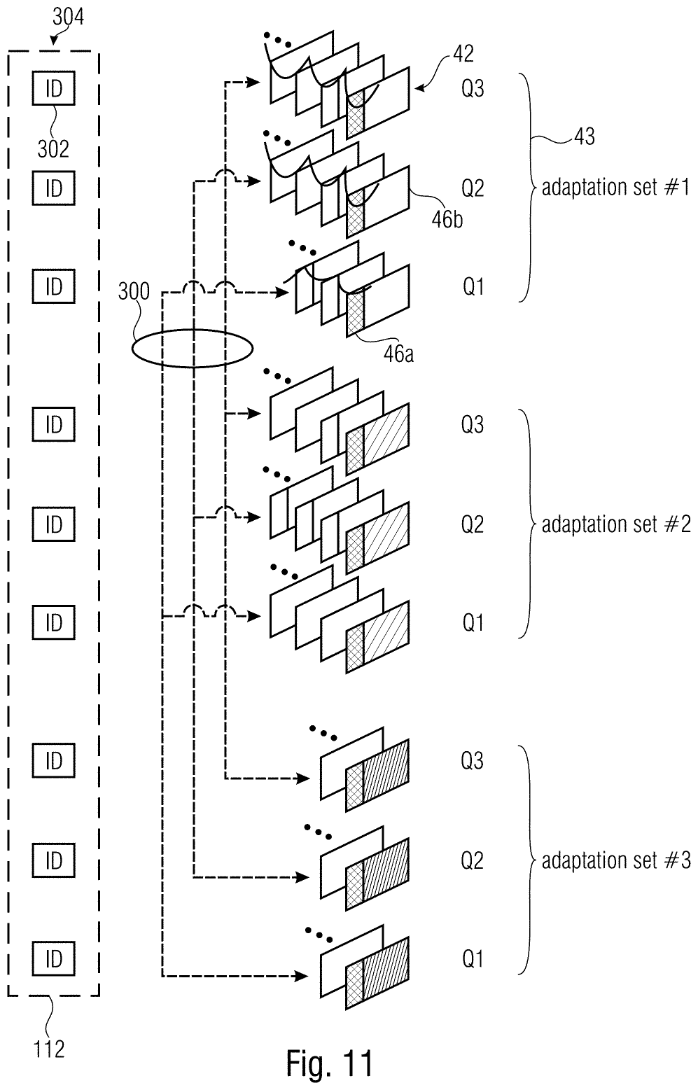

The afore-mentioned manifest file or MPD which may be used by retriever 18 to sequentially retrieve the fragments may be part of data 10. An example thereof is depicted herein, too, at reference sign 100 in FIG. 10. File 100 may be an XML file, for example. It may have, as exemplified, for each representation 42 shown previously, a syntax portion 102 which defines same. Here, each syntax portion defines an adaptation set of representations. See the example shown in FIG. 11. Each adaptation set, thus, collects representations 42 of differing quality Q # and bitrate, respectively. Quality difference may relate to SNR and/or spatial resolution or the like. As far as the mapping 50 is concerned representations 42 within one adaptation set 43 may correspond to each other. That is, mapping 50 is equal with even the regions 46a and 46b and the video frame sizes coinciding, or mapping 50 is equal accept for the dimensions of the regions 46a and 46b and the video frame sizes being scaled relative to each other according to the spatial resolution differences between the representations within one adaptation set 43.

The syntax portions 102 may indicate, for each adaptation set, the mapping 50 or a viewport direction 104 of the higher-resolution region, e.g. 46b, of the representations within the respective adaptation set. Further, each syntax portion 102 may indicate, for each representation within the adaptation set defined by the respective syntax portion 102, the fetching addresses 106 for fetching the fragments 64 of the respective representation such as via indication of a computation rule. Beyond this, each syntax portion 102 may comprise an indication 108 of the positions of the RAPs 66 and an indication 110 of the positions of the SPs 68 within the respective representation. The RAPs may coincide between the adaptation sets. The SPs may coincide between the adaptation sets. Additionally, the manifest file 100 may, optionally, comprise an information 112 on whether the SPs are additionally available for switching from any of the representations of an adaptation set to a representation of any of the other adaptation sets. Information 112 may be embodied in many different forms. Information may signal globally for all adaptation sets that the SPs may be used to switch between representations of equal quality level (for which the mapping 50 is the same), but of different adaptation sets. This switching restriction is illustrated at 300 in FIG. 11 by dashed lines interconnecting representations of equal quality level Q # of differing adaptation sets between which switching may be allowed. Alternatively, as depicted at 304, information 112 may be embodied by indices 302 spent for each representation 42 of each adaptation set 43, with the convention that switching between representations of equal index is allowed at SPs. Thus, where allowed, the retriever 18 does not need to retrieve the initialization segment 70 of the presentation it switches to, and a decoder's re-initialization is effectively avoided. Even alternatively, an ID may be spent for each adaptation set, i.e. globally for all representations within each adaptation set, thereby indicating that SPs of all representations of adaptation sets of equal ID may be used for switching between different adaptation sets. Even alternatively, the information 112 may be co-signaled, i.e. may be indicated, by a profile indicator which is able to associate the manifest file with different profiles. One of same may be an OMAF profile which implies that certain constraints apply, such as a) switching is allowed between all representations of the adaptation sets, between representations of different adaptation sets which coincide in quality level, or between representations of different adaptation sets which differ by less than a certain amount in quality level, or the like. The latter certain amount may also be signaled as part of the information 112. The profile indicator could be, for instance, an m-ary syntax element which, by assuming one certain state, casts the OMAF profile. It would be comprised by information 112. The retriever acts accordingly in determining possible switching points between representations of different viewport direction, i.e. representations belonging to different adaptation sets, or, differently speaking, in searching SPs of representations which belong to an adaptation set which is associated with a wanted viewport direction.

It can be noted that the above concepts can also manifest themselves in context of a session negotiation in a real time communication oriented scenario such as low latency streaming via RTP or WebRTC. In such a scenario, a server in possession of a desired media acts as one communication end point in a conversational system while the client in need of the desired media data acts as another communication end point. Typically, during establishment of the communication session, i.e. streaming session, certain media characteristics and requirements are exchanged or negotiated, much like the objective of the media presentation description in HTTP based media streaming that informs one end point about the offered media characteristics and requirements, e.g. codec level or RWP details.

In such a scenario, it could, for instance, be part of an Session Description Protocol (SDP) exchange that characteristics about the RWP of the media data are exchanged or negotiated, e.g. a server informs the client about the availability of a) the media data without RWP (bitrate-wise inefficient), b) classic RWP (full picture RAP, which is more efficient than a)) or c) dynamic RWP as per the above description (partial picture RAP with highest bitrate-wise efficiency). The resulting scenario would correspond to the description of FIG. 7 with the following modifications: Server 10 and client 14 would represent communication end points or communication devices between a video streaming is to be established from end point 10, which might still be called server, to 14, which might still be called client. The client could comprise components 20 and 22 and optionally 24 and 26, and the retriever would be replaced by a negotiator which performs the negotiations. The server does not have to have access to various representations of the video as taught above. The video to be streamed may be rendered on the fly or by prepared, and the versions which are offered and mutually discriminated in a corresponding offer message, which somehow corresponds to the manifest in the streaming environment described so far with respect to FIG. 7, and which is sent from server 10 to client 14, merely differ in the manner of a) not using region wise packing, b) using region wise packing with static regions only, and c) using region wise packing including at least one dynamic region. Option a is optional and may be left off. The client sends an answer message to the server, the answer message selecting one of the offered media versions. Option c results into the video bitstream transmitted from server 10 to client 14 to possibly conform to the above description, i.e. it may have the RWP messages 58 incorporated therein. This option might be selectable or allowed to be selected by the client 14 only, if the decoder 22 and/or the media converter 20 is able to deal with the dynamic regions. In case of using option b, it might be up to the server 10 to send an initialization header each time the mapping 50 changes with one dynamic region. That is, the server 10 would offer a video to a client in at least two versions: one where the video is encoded in a continuous video bitstream to be sent from server to client in a manner where the video frames of the video are subdivided into a first set of one or more regions and a second set of one or more regions, wherein a mapping between the video frames and a scene remains constant within the first set of one or more regions, while being dynamic or varying in the second set of one or more regions, and another one where the video is encoded in onto a concatenation of video bitstreams to be sent from server to client and covering temporally consecutive intervals of the video in a manner wherein, within each video bitstream of the concatenation, the video frames of the video are subdivided into a set of regions, wherein the mapping between the video frames and the scene remains constant within the set of regions, and among all of the concatenation of video bitstreams, the set of regions comprises a first set of one or more regions and a second set of one or more regions, wherein the mapping between the video frames and the scene remains constant within the first set of one or more regions with respect to the concatenation, while being dynamic or varying in the second set of one or more regions. The server may, as discussed, insert initialization headers between the concatenation of video bitstreams in the second option. These initialization headers might have the mapping information for the respect video bitstream they relate to (and precede, respectively). In the first option, the video bitstream might be construed as discussed above. Fragmentation into fragments may apply or not. Thus, the server would be configured to send an offering message offering both versions of the video to the client in a negotiation phase preceding the actual streaming of the video to the client, and receive a corresponding answering message from the client which selects one of the options offered. Depending on the option offered, the server would provide the video in the manner discussed. The client would be configured to receive the offer message and answer by way of a respective answer message selecting one of the offered versions. If the first option is chosen a decoder and/or a media converter inside the client would operate in the manner described above to handle the dynamic RWP.

In another scenario, a client uses the above concepts to inform a server of his desired dynamic RWP configuration, e.g. what resolution of a static overview picture part, static region, it desires or what field of view the dynamic picture part, dynamic region, covering the viewport shall contain. Given such a negotiation exchange and configuration a client would only need to update the other end-point, i.e. the server, on the current viewing direction to be contained in the dynamic region and the corresponding end-point, i.e. the server, would know how to update the dynamic part so that the new viewing direction is properly shown. That is, here, the sever 10 might not offer versions of just-mentioned options b and c, but merely option c. On the other hand, while in the previous paragraph the variation of the mapping might have its origin on server side, here, the mapping change is initiated on client side, such as via a sensor signal as discussed in FIG. 7, with the client 14 sending respective control messages to server 10. The resulting scenario would correspond to the variation of FIG. 7 described in the previous paragraph with the modification that the offer messages and the answer message are optional. The client 14 expects to receive from server 14 a video bitstream according to option c. To control the mapping wrt the dynamic region(s), the client sends control signals indicating the change in mapping 50 to the server. The thus streamed video bitstream could correspond to the result described above, i.e. having the mapping information 58 contained therein. Fragmentation into fragments may apply or not. Here, intermediate control messages indicative of a change of the mapping wrt the dynamic region(s) may be distinguished from a negotiation control message sent from the client to the server, indicative of the mapping wrt the static region(s) and, optionally, a first setting of the mapping wrt the dynamic region(s). Thus, the server would be configured to provide the video in the manner discussed above according to option c and respond to intermediate control messages from the client to vary the mapping 50 wrt to dynamic region(s) of subsequent frames of the video bitstream. Optionally, the server would respond to a negotiation control message to set up the mapping 50 initially also wrt to the static region(s). In combination with the negotiation between options b and c described above, it could be that the server, in case of option b being selected, responds to the intermediate control messages by ceasing streaming a current video bitstream of a current static RWP and starting streaming a subsequent video bitstream of a different static RWP as indicated by the current intermediate control message. The client would be configured to receive the offer message and answer by way of a respective answer message selecting one of the offered versions. If the option c is chosen a decoder and/or a media converter inside the client would operate in the manner described above to handle the dynamic RWP

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

The inventive signals such as media files, video bitstreams, date collections and manifest files discussed above can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitionary.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are preferably performed by any hardware apparatus.

The apparatus described herein may be implemented using a hardware apparatus, or using a computer, or using a combination of a hardware apparatus and a computer.

The apparatus described herein, or any components of the apparatus described herein, may be implemented at least partially in hardware and/or in software.

The methods described herein may be performed using a hardware apparatus, or using a computer, or using a combination of a hardware apparatus and a computer.

The methods described herein, or any components of the apparatus described herein, may be performed at least partially by hardware and/or by software.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. Data having a scene encoded thereinto for immersive video streaming, comprising
a set of representations, each representation comprising a video, video frames of which are subdivided into regions,
wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions,
wherein each of the representations is fragmented into fragments covering temporally consecutive time intervals of the scene, each fragment of each representation comprising mapping information on the mapping between the video frames and the scene with respect to the second set of one or more regions of the video frames within the respective fragment,
wherein the video frames are encoded such that the set of representations comprises
for each representation, a set of random access points for which video frames within a fragment of the respective representation, which is temporally aligned to any of the set of random access points, are encoded independent from previous fragments of the respective representation within the first and second sets of one or more regions, and
for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

2. The data of claim 1, wherein the mapping information comprised by each fragment of each representation additionally comprises information on the mapping between the video frames and the scene with respect to the first set of one or more regions of the video frames within the respective fragment.

3. The data of claim 1, wherein each representation comprises the video in form of a video bitstream, and the mapping information is comprised by supplemental enhancement information messages of the video stream.

4. The data of claim 1, wherein each representation comprises the video in a media file format and the mapping information is comprised by a media file format header of the fragments.

5. The data of claim 4, wherein each representation comprises an initialization header comprising information on the mapping between the video frames and the scene with respect to the first set of one or more regions of the video frames within the fragments of the respective representation.

6. The data of claim 1, wherein the mapping information distinguishes between the first set of one or more regions of the video frames on the one hand and the second set of one or more regions of the video frames on the other hand.

7. The data of claim 1, wherein the mapping information defines the mapping for a predetermined region in terms of one or more of
the predetermined region's intra-video-frame position,
the predetermined region's spherical scene position, and
the predetermined region's video-frame to spherical scene projection.

8. The data of claim 1, wherein each representation comprises the video in a media file format and the representations' fragments are media file fragments.

9. The data of claim 1, wherein each representation comprises the video in a media file format and the representations' fragments are runs of one or more media file fragments.

10. The data of claim 1, further comprising a manifest file which describes the representations for the immersive video streaming, wherein the manifest file indicates access addresses for retrieving each of the representations in units of fragments or runs of one or more fragments.

11. The data of claim 1, further comprising a manifest file which describes the representations for the immersive video streaming, wherein the manifest file indicates the set of random access points and the set of switching points.

12. The data of claim 11, wherein the manifest file indicates the set of random access points for each representation individually.

13. The data of claim 11, wherein the manifest file indicates the set of switching points for each representation individually.

14. The data of claim 1, the set of random access points coincide among the representations.

15. The data of claim 1, the set of switching points coincide among the representations.

16. The data of claim 1, further comprising a manifest file which describes the representations for the immersive video streaming, wherein the manifest file indicates the set of switching points and comprises an m-ary syntax element set to one of m states of the m-ary syntax element indicating that an initialization header of a representation switched to at any of the switching points needs not to be retrieved along with the fragment of said representation at said switching point.

17. The data of claim 1, wherein the video frames have the second portion of the scene encoded into the second set of one or more regions in a manner where the second portion differs among the representations and the second set of one or more regions coincides in number among the representations or is common to all representations.

18. The data of claim 1, wherein the video frames have the second portion of the scene encoded into the second set of one or more regions in a manner where the second portion coincides in size among the representations with differing in scene position among the representations and the second set of one or more regions is common to all representations.

19. The data of claim 1, wherein the each representation comprises the video in form of a video bitstream wherein, for each representation, the video frames are encoded using motion-compensation prediction so that the video frames are predicted within the first set of one or more regions from reference portions within reference video frames exclusively residing within the first set of one or more regions.

20. The data of claim 1, wherein, for each representation, the mapping between the videos frames of the respective representation and the scene remains constant within the first set of one or more regions, and the mapping between the videos frames and the scene differs among the representations within the second set of one or more regions in terms of
a location of an image of the second set of one or more regions of the video frames in the scene according to the mapping between the videos frames and the scene and/or
a circumference of the second set of one or more regions and/or
a sample mapping between the second set of one or more regions and the image thereof in the scene.

21. The data of claim 1, wherein the second set of one or more regions samples the scene at higher spatial resolution than the first set of one or more regions.

22. The data of claim 1, wherein the first set of one or more regions samples the scene within a first image of the first set of one or more regions in the scene according to the mapping between the video frames and scene which is larger than a second image of the second set of one or more regions according to the mapping between the video frames and the scene within which the second set of one or more regions samples the scene.

23. The data of claim 1, wherein the data is offered at a server to a client for download.

24. A manifest file comprising
a first syntax portion defining a first adaptation set of first representations, first RAPs for random access to each of the first representations and first SPs for switching from one of the first representations to another,
a second syntax portion defining a second adaptation set of second representations, second RAPs for random access to each of the second representations and second SPs for switching from one of the second representations to another, and
an information on whether the first SPs and second SPs are additionally available for switching from one of the first representations to one of the second presentations and from one of the second representations to one of the first presentations, respectively.

25. The manifest file of claim 24, wherein the information comprises an ID for each representation, thereby indicating the availability of SPs of representations of equal ID for switching between representations of different adaptation sets.

26. The manifest file of claim 24, wherein the first syntax portion indicates for the first representations a first viewport direction, and the second syntax portion indicates for the second representations a second viewport direction.

27. The manifest file of claim 24, wherein the first syntax portion indicates access addresses for retrieving fragments of each of the first representations, and the second syntax portion indicates access addresses for retrieving fragments of each of the second representations.

28. The manifest file of claim 24, wherein the first and second random access points of the first representations and the second representations coincide.

29. The manifest file of claim 24, wherein the first and second switching points of the first representation and the second representation coincide.

30. The manifest file of claim 24, wherein the information is an m-ary syntax element which, if set to one of m states of the m-ary syntax element, indicates that the first SPs and second SPs are additionally available for switching from one of the first representations to one of the second presentations and from one of the second representations to one of the first presentations, respectively, so that an initialization header of a representation switched to at any of the switching points needs not to be retrieved along with the fragment of said representation at said switching point.

31. The manifest file of claim 24, wherein the information comprises an ID for each of the first and second representations, respectively, thereby indicating that, among first and second representations for which the information's ID is equal, the first SPs and second SPs of said representations are available for switching between the first and the second adaptation sets so that an initialization header of a representation switched to at any of the switching points needs not to be retrieved along with the fragment of said representation at said switching point.

32. The manifest file of claim 24, wherein the information comprises an ID for each of the first and second adaptation sets, respectively, thereby indicating that, if the IDs are equal, the first SPs and second SPs of all representations of the first and second adaptation sets are available for switching between the first and the second adaptation sets so that an initialization header of a representation switched to at any of the switching points needs not to be retrieved along with the fragment of said representation at said switching point.

33. The manifest file of claim 24, wherein the information comprises an profile identifier discriminating between different profiles the first and second adaptation sets conform to.

34. The manifest file of claim 33, wherein one of the different profiles indicates a OMAF profile wherein the first SPs and second SPs are additionally available for switching from one of the first representations to one of the second presentations and from one of the second representations to one of the first presentations, respectively.

35. A media file comprising a video, comprising
a sequence of fragments into which consecutive time intervals of a scene are coded,
wherein video frames of the video comprised by the media file are subdivided into regions, wherein the regions of the video frames spatially coincide among video frames within different media file fragments, with respect to a first set of one or more regions,
wherein the videos frames have the scene encoded thereinto, wherein a mapping between the videos frames and the scene is common among all fragments within a first set of one or more regions, and differs among the fragments within a second set of one or more regions outside the first set of one or more regions,
wherein each fragment comprises mapping information on the mapping between the video frames and the scene with respect to the second set of one or more regions of the video frames within the respective fragment,
wherein the video frames are encoded such that the fragments comprise
predetermined ones within which video frames are encoded independent from previous fragments within the second set of one or more regions, but predictively dependent on previous fragments differing in the mapping within the second set of one or more regions compared to the predetermined fragments, within the first set of one or more regions.

36. The media file of claim 35, wherein the mapping information comprised by each fragment of each representation additionally comprises information on the mapping between the video frames and the scene with respect to the first set of one or more regions of the video frames within the respective fragment.

37. The media file of claim 35, wherein the sequence of fragments comprise the video in form of a video bitstream, and the mapping information is comprised by supplemental enhancement information messages of the video stream.

38. The media file of claim 35, wherein the mapping information is comprised by a media file format header of the fragments.

39. The media file of claim 38, further comprising a media file header (initialization header) comprising information on the mapping between the video frames and the scene with respect to the first set of one or more regions of the video frames within the fragments of the respective representation.

40. The media file of claim 35, wherein the mapping information distinguishes between the first set of one or more regions of the video frames on the one hand and the second set of one or more regions of the video frames on the other hand.

41. The media file of claim 35, wherein the mapping information defines the mapping for a predetermined region in terms of one or more of
the predetermined region's intra-video-frame position,
the predetermined region's spherical scene position,
the predetermined region's video-frame to spherical scene projection.

42. The media file of claim 35, wherein the fragments are media file fragments.

43. The media file of claim 35, wherein the fragments are runs of one or more media file fragments.

44. The media file of claim 35, wherein the video frames are encoded using motion-compensation prediction so that the video frames are predicted within the first set of one or more regions from reference portions within reference video frames exclusively residing within the first set of one or more regions.

45. The media file of claim 35, wherein the mapping between the videos frames and the scene remains differs among the fragments within the second set of one or more regions in terms of
a location of an image of the second set of one or more regions of the video frames in the scene according to the mapping between the videos frames and the scene and/or
a circumference of the second set of one or more regions and/or
a sample mapping between the second set of one or more regions and the image of the scene.

46. The media file of claim 35, wherein the second set of one or more regions samples the scene at higher spatial resolution than the first set of one or more regions.

47. The media file of claim 35, wherein the first set of one or more regions samples the scene within a first image of the first set of one or more regions according to the mapping between the video frames and scene which is larger than a second image of the second set of one or more regions samples according to the mapping between the video frames and the scene within which the second set of one or more regions samples the scene.

48. An apparatus for generating data encoding a scene for immersive video streaming, configured to
generate a set of representations, each representation comprising a video, video frames of which are subdivided into regions, such that
the regions of the video frames spatially coincide among the representations with respect to a first set of one or more regions, wherein a mapping between the video frames and the scene is common to all representations within the first set of one or more regions and differs among the representations within a second set of one or more regions outside the first set of one or more regions,
each of the representations is fragmented into fragments covering temporally consecutive time intervals of the scene,
wherein the apparatus is configured to
provide each fragment of each representation with mapping information on the mapping between the video frames and the scene with respect to the second set of one or more regions of the video frames within the respective fragment,
wherein the video frames are encoded such that the set of representations comprise
for each representation, a set of random access points for which video frames within a fragment of the respective representation, which is temporally aligned to any of the set of random access points, are encoded independent from previous fragments of the respective representation within the first and second sets of one or more regions, and
for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

49. An apparatus for streaming scene content from a server by immersive video streaming, the server offering the scene by way of
a set of representations, each representation comprising a video, video frames of which are subdivided into regions,
wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions,
wherein each of the representations is fragmented into fragments covering temporally consecutive time intervals of the scene, each fragment of each representation comprising mapping information on the mapping between the video frames and the scene with respect to the second set of one or more regions of the video frames within the respective fragment,
wherein the video frames are encoded such that the set of representations comprise
for each representation, a set of random access points for which video frames within a fragment of the respective representation, which is temporally aligned to any of the set of random access points, are encoded independent from previous fragments of the respective representation within the first and second sets of one or more regions, and
for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions,
wherein the apparatus is configured to switch from one representation to another at one of the switching points of the other representation.

50. A server offering a scene for immersive video streaming, the server offering the scene by way of
a set of representations, each representation comprising a video, video frames of which are subdivided into regions,
wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions,
wherein each of the representations is fragmented into fragments covering temporally consecutive time intervals of the scene, each fragment of each representation comprising mapping information on the mapping between the video frames and the scene with respect to the second set of one or more regions of the video frames within the respective fragment,
wherein the video frames are encoded such that the set of representations comprise
for each representation, a set of random access points for which video frames within a fragment of the respective representation, which is temporally aligned to any of the set of random access points, are encoded independent from previous fragments of the respective representation within the first and second sets of one or more regions, and
for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

51. A video decoder configured to decode a video from a video bitstream, configured to
derive from the video bitstream a subdivision of video frames of the video into a first set of one or more regions and a second set of one or more regions, wherein a mapping between the video frames and a scene remains constant within the first set of one or more regions,
wherein the video decoder is configured to
check mapping information updates which update the mapping for the second set of one or more regions in the video bitstream, and recognize a partial random access point with respect to the second set of one or more regions responsive to a change of the mapping with respect to the second set of one or more regions, and/or
interpret the video frames' subdivision as a promise that motion-compensation prediction used by the video bitstream to encode the video frames, predicts video frames within the first set of one or more regions from reference portions within reference video frames exclusively residing within the first set of one or more regions, and/or
inform a renderer for rendering an output video of the scene out of the video on the mapping between the video frames and the scene by way of mapping information meta data accompanying the video, wherein the mapping information meta data indicates the mapping between the video frames and the scene once or at a first update rate with respect to the first set of one or more regions and at a second update rate with respect to the second set of one or more regions which is higher than the first update rate.

52. The decoder of claim 51, wherein the video bitstream comprises updates of the mapping information with respect to the first set of one or more regions and the decoder is configured to distinguish the first set from the second set by a syntax order at which the mapping information sequentially relates to the first and second set and/or by association syntax elements associated with the first and second sets.

53. The decoder of claim 51, configured to read the mapping information from supplemental enhancement information messages of the video bitstream.

54. The decoder of claim 51, wherein the mapping information defines the mapping for a predetermined region in terms of one or more of
the predetermined region's intra-video-frame position,
the predetermined region's spherical scene position,
the predetermined region's video-frame to spherical scene projection.

55. The decoder of claim 51, wherein the mapping between the videos frames of and the scene remains constant within the first set of one or more regions, and varies within the second set of one or more regions in terms of
a location of an image of the second set of one or more regions of the video frames in the scene according to the mapping between the videos frames and the scene and/or
a circumference of the second set of one or more regions and/or
a sample mapping between the second set of one or more regions and the image of the scene.

56. The decoder of claim 51, configured to
check mapping information updates which update the mapping for the second set of one or more regions in the video bitstream, and recognize a partial random access point with respect to the second set of one or more regions responsive to a change of the mapping with respect to the second set of one or more regions, and, if recognizing the partial access point, de-allocate buffer space in a decoded picture buffer of the decoder consumed by the second set of one or more regions of video frames preceding the partial random access point.

57. The decoder of claim 51, configured to
interpret the video frames' subdivision as a promise that motion-compensation prediction used by the video bitstream to encode the video frames, predicts video frames within the first set of one or more regions from reference portions within reference video frames exclusively residing within the first set of one or more regions, and use the promise so as to commence decoding an edge portion of the first set of one or more regions of a current video frame prior to decoding an adjacent portion of the second set of one or more regions of a motion compensation reference video frame of the current video frame.

58. The decoder of claim 51, configured to
inform a renderer for rendering an output video of the scene out of the video on the mapping between the video frames and the scene by way of mapping information meta data accompanying the video, wherein the mapping information meta data indicates the mapping between the video frames and the scene once.

59. A renderer for rendering an output video of a scene out of a video and mapping information meta data which indicates a mapping between the video's video frames and the scene, configured to
distinguish, on the basis of the mapping information meta data, a first set of one or more regions of the video frames for which the mapping between the video frames and the scene remains constant, and a second set of one or more regions within which the mapping between the video frames and the scene varies according to updates of the mapping information meta data.

60. A video bitstream video frames of which have encoded thereinto a video, the video bitstream comprising
Information on a subdivision of the video frames into regions, wherein the information discriminates between a first set of one or more regions within which a mapping between the video frames and a scene remains constant, and a second set of one or more region outside the first set one or more regions, and
mapping information on the mapping between the video frames and the scene, wherein the video bitstream comprises updates of the mapping information with respect to the second set of one or more regions.

61. The video bitstream of claim 60, wherein the mapping the mapping between the video frames and a scene varies within the second set of one or more regions.

62. The video bitstream of claim 60, wherein the video bitstream comprises updates of the mapping information with respect to the first set of one or more regions.

63. The video bitstream of claim 60, wherein the mapping information is comprised by supplemental enhancement information messages of the video bitstream.

64. The video bitstream of claim 60, wherein the mapping information defines the mapping for a predetermined region in terms of one or more of
the predetermined region's intra-video-frame position,
the predetermined region's spherical scene position,
the predetermined region's video-frame to spherical scene projection.

65. The video bitstream of claim 60, wherein the mapping between the videos frames of and the scene remains constant within the first set of one or more regions, and varies within the second set of one or more regions in terms of
a location of an image of the second set of one or more regions of the video frames in the scene according to the mapping between the videos frames and the scene and/or
a circumference of the second set of one or more regions and/or a sample mapping between the second set of one or more regions and the image of the scene.

66. The video bitstream of claim 60, wherein the second set of one or more regions samples the scene at higher spatial resolution than the first set of one or more regions.

67. The video bitstream of claim 60, wherein the first set of one or more regions samples the scene within a first image of the first set of one or more regions according to the mapping between the video frames and scene which is larger than a second image of the second set of one or more regions samples according to the mapping between the video frames and the scene within which the second set of one or more regions samples the scene.

68. The video bitstream of claim 60, wherein the video frames are encoded using motion-compensation prediction so that the video frames are predicted within the first set of one or more regions from reference portions within reference video frames exclusively residing within the first set of one or more regions.

69. The video bitstream of claim 60, wherein the video frames are encoded using motion-compensation prediction so that the video frames are without prediction-dependency within the second set of one or more regions from reference portions within reference video frames differing in terms of the mapping between the video frames and the scene within the one or more second regions.

70. A method for generating data encoding a scene for immersive video streaming, comprising
generating a set of representations, each representation comprising a video, video frames of which are subdivided into regions, such that
the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions,
each of the representations is fragmented into fragments covering temporally consecutive time intervals of the scene,
wherein the method is configured to
provide each fragment of each representation with mapping information on the mapping between the video frames and the scene with respect to the second set of one or more regions of the video frames within the respective fragment,
wherein the video frames are encoded such that the set of representations comprise
for each representation, a set of random access points for which video frames within a fragment of the respective representation, which is temporally aligned to any of the set of random access points, are encoded independent from previous fragments of the respective representation within the first and second sets of one or more regions, and
for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions.

71. A method for streaming scene content from a server by immersive video streaming, the server offering the scene by way of
a set of representations, each representation comprising a video, video frames of which are subdivided into regions,
wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions,
wherein each of the representations is fragmented into fragments covering temporally consecutive time intervals of the scene, each fragment of each representation comprising mapping information on the mapping between the video frames and the scene with respect to the second set of one or more regions of the video frames within the respective fragment,
wherein the video frames are encoded such that the set of representations comprise
for each representation, a set of random access points for which video frames within a fragment of the respective representation, which is temporally aligned to any of the set of random access points, are encoded independent from previous fragments of the respective representation within the first and second sets of one or more regions, and
for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions,
wherein the method is configured to switch from one representation to another at one of the switching points of the other representation.

72. A method for decoding a video from a video bitstream, configured to
derive from the video bitstream a subdivision of video frames of the video into a first set of one or more regions and a second set of one or more regions, wherein a mapping between the video frames and a scene remains constant within the first set of one or more regions,
wherein the method for decoding is configured to
check mapping information updates which update the mapping for the second set of one or more regions in the video bitstream, and recognize a partial random access point with respect to the second set of one or more regions responsive to a change of the mapping with respect to the second set of one or more regions, and/or
interpret the video frames' subdivision as a promise that motion-compensation prediction used by the video bitstream to encode the video frames, predicts video frames within the first set of one or more regions from reference portions within reference video frames exclusively residing within the first set of one or more regions, and/or
inform a renderer for rendering an output video of the scene out of the video on the mapping between the video frames and the scene by way of mapping information meta data accompanying the video, wherein the mapping information meta data indicates the mapping between the video frames and the scene once or at a first update rate with respect to the first set of one or more regions and at a second update rate with respect to the second set of one or more regions which is higher than the first update rate.

73. A method for rendering an output video of a scene out of a video and mapping information meta data which indicates a mapping between the video's video frames and the scene, configured to
distinguish, on the basis of the mapping information meta data, a first set of one or more regions of the video frames for which the mapping between the video frames and the scene remains constant, and a second set of one or more regions within which the mapping between the video frames and the scene varies according to updates of the mapping information meta data.

74. A non-transitory digital storage medium having a computer program stored thereon to perform the method for streaming scene content from a server by immersive video streaming, the server offering the scene by way of
a set of representations, each representation comprising a video, video frames of which are subdivided into regions,
wherein the regions of the video frames spatially coincide among the representations with respect to a first set of one or more regions, wherein a mapping between the videos frames and the scene is common to all representations within the first set of one or more regions and differs among the representations within second set of one or more regions outside the first set of one or more regions,
wherein each of the representations is fragmented into fragments covering temporally consecutive time intervals of the scene, each fragment of each representation comprising mapping information on the mapping between the video frames and the scene with respect to the second set of one or more regions of the video frames within the respective fragment,
wherein the video frames are encoded such that the set of representations comprise
for each representation, a set of random access points for which video frames within a fragment of the respective representation, which is temporally aligned to any of the set of random access points, are encoded independent from previous fragments of the respective representation within the first and second sets of one or more regions, and
for each representation, a set of switching points for which video frames within a fragment of the respective representation, which is temporally aligned to any of the set of switching points, are encoded independent from the previous fragments of the respective representation within the second set of one or more regions, but predictively dependent on the previous fragments within the first set of one or more regions,
wherein the method is configured to switch from one representation to another at one of the switching points of the other representation,
when said computer program is run by a computer.

75. A non-transitory digital storage medium having a computer program stored thereon to perform the method for decoding a video from a video bitstream, configured to
derive from the video bitstream a subdivision of video frames of the video into a first set of one or more regions and a second set of one or more regions, wherein a mapping between the video frames and a scene remains constant within the first set of one or more regions,
wherein the method for decoding is configured to
check mapping information updates which update the mapping for the second set of one or more regions in the video bitstream, and recognize a partial random access point with respect to the second set of one or more regions responsive to a change of the mapping with respect to the second set of one or more regions, and/or
interpret the video frames' subdivision as a promise that motion-compensation prediction used by the video bitstream to encode the video frames, predicts video frames within the first set of one or more regions from reference portions within reference video frames exclusively residing within the first set of one or more regions, and/or
inform a renderer for rendering an output video of the scene out of the video on the mapping between the video frames and the scene by way of mapping information meta data accompanying the video, wherein the mapping information meta data indicates the mapping between the video frames and the scene once or at a first update rate with respect to the first set of one or more regions and at a second update rate with respect to the second set of one or more regions which is higher than the first update rate,
when said computer program is run by a computer.
